(19) United States
(12) Patent Application Publication
(10) Pub. No.: US 2016/0179926 A1
(43) Pub. Date: Jun. 23, 2016

(54) MUSIC PLAYING SERVICE

(71) Applicant: Nokia Technologies Oy, Espoo (FI)

(72) Inventors: Jussi LEPPÄNEN, Tampere (FI); Lasse LAAKSONEN, Nokia (FI); Miikka VILERMO, Siuro (FI); Pasi SAARI, Jyvaskyla (FI)

(21) Appl. No.: 14/978,983

(22) Filed: Dec. 22, 2015

(30) Foreign Application Priority Data
Dec. 23, 2014 (GB) 1423031.2

(51) Int. Cl. G06F 17/30; H04L 29/06; H04L 29/08

(52) U.S. Cl. CPC G06F 17/30598; H04L 67/1095; G06F 17/3053; H04L 65/4069

(57) ABSTRACT

The invention relates to a method, comprising defining a subset of users for a user from a group of users who play music items which are related to a same music item, receiving playing of the music items from users of the subset; and providing the playing of the music items to the user. The invention further relates to an apparatus and a computer program product that perform the method.

### CROSS REFERENCE TO RELATED APPLICATION

This application claims priority to and the benefit of United Kingdom application number GB1423031.2, filed Dec. 23, 2014, the entire contents of which are hereby incorporated by reference.

### BACKGROUND

Today's people use internet for several kinds of communication and doing things together. By the help of the internet, it is possible to find people or reach people who are willing and capable to participate in ongoing activity virtually. This is especially nice if such people are not in physical vicinity. It may be possible, for example, to find a virtual chess game friend, virtual jogging companion and also a virtual band in which to join.

### SUMMARY

Now there has been invented an improved method and technical equipment implementing the method. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, there is provided a method, comprising defining a subset of users for a user from a group of users who play music items which are related to a same music item, receiving playing of the music items from users of the subset, and providing the playing of the music items to the user.

According to an embodiment, the subset of users is automatically defined for the user on the basis of user's preferences, skill level of users of the group, collected reputation score of users of the group, the playing style match between the user and users of the group or history of playing together. According to an embodiment, the subset of users is defined by the user.

According to an embodiment, a subset of users is defined for each user of the group. According to an embodiment, playing of the music items is provided in real time to the user. According to an embodiment, playing of the music items is provided simultaneously to the user. According to an embodiment, at least one received music item is played with a different music instrument than at least one other received music item. According to an embodiment, the playing of the music items is combined and the combined playing is provided to the user. According to an embodiment, the method further comprises defining a virtual view arranged to be displayed with playing of the music items. According to an embodiment, virtual view is defined on the basis of the degree of synchronization of playing of users of a subset. According to an embodiment, the method further comprises receiving image data from users of the subset while playing the music items; and providing received image data arranged to be displayed to said at least one user simultaneously with playing of the music items. According to an embodiment, at least one further user joins the subgroup for playing a further music item related to said same music item. According to an embodiment, the playing of the music item of said at least one further user is provided to the user with the playing of the music items from other users of the subset. According to an embodiment, the playing of the music item of said at least one further user is combined with the playing of the music items from users of the subset.

According to a second aspect, there is provided an apparatus comprising at least one processor, memory including computer program code, the memory and the computer program code configured to, with the at least one processor, cause the apparatus to perform at least the following: define a subset of users for a user from a group of users who play music items which are related to a same music item, receive playing of the music items from users of the subset, and provide the playing of the music items to the user

According to an embodiment, the subset of users is automatically defined for the user on the basis of user's preferences, skill level of users of the group, collected reputation score of users of the group, the playing style match between the user and users of the group or history of playing together. According to an embodiment, the subset of users is defined by the user. According to an embodiment, a subset of users is defined for each user of the group. According to an embodiment, playing of the music items is provided in real time to the user. According to an embodiment, playing of the music items is provided simultaneously to the user. According to an embodiment, at least one received music item is played with a different music instrument than at least one other received music item. According to an embodiment, the playing of the music items is combined and the combined playing is provided to the user. According to an embodiment, the apparatus is further caused to define a virtual view arranged to be displayed with playing of the music items. According to an embodiment, virtual view is defined on the basis of the degree of synchronization of playing of users of a subset. According to an embodiment, the apparatus is further caused to receive image data from users of the subset while playing the music items, and provide received image data arranged to be displayed to said at least one user simultaneously with playing of the music items. According to an embodiment, at least one further user joins the subgroup for playing a further music item related to said same music item. According to an embodiment, the playing of the music item of said at least one further user is provided to the user with the playing of the music items from other users of the subset. According to an embodiment, the playing of the music item of said at least one further user is combined with the playing of the music items from users of the subset.

According to a third aspect, there is provided an apparatus comprising: means for defining a subset of users for a user from a group of users who play music items which are related to a same music item, means for receiving playing of the music items from users of the subset, and means for providing the playing of the music items to the user.

According to an embodiment, the apparatus comprises means for defining a virtual view arranged to be displayed with playing of the music items. According to an embodiment, the apparatus comprises means for receiving image data from users of the subset while playing the music items, and provide received image data arranged to be displayed to said at least one user simultaneously with playing of the music items.

According to a fourth aspect, there is provided a computer program embodied on a non-transitory computer readable medium, the computer program comprising instructions causing, when executed on at least one processor, at least one apparatus to define a subset of users for a user from a group of users who play music items which are related to a same music item, receive playing of the music items from users of the subset, and provide the playing of the music items to the user.

According to an embodiment, the subset of users is automatically defined for the user on the basis of user's preferences, skill level of users of the group, collected reputation score of users of the group, the playing style match between the user and users of the group or history of playing together. According to an embodiment, the subset of users is defined by the user. According to an embodiment, a subset of users is defined for each user of the group. According to an embodiment, playing of the music items is provided in real time to the user. According to an embodiment, playing of the music items is provided simultaneously to the user. According to an embodiment, at least one received music item is played with a different music instrument than at least one other received music item. According to an embodiment, the playing of the music items is combined and the combined playing is provided to the user. According to an embodiment, the apparatus is further caused to define a virtual view arranged to be displayed with playing of the music items. According to an embodiment, virtual view is defined on the basis of the degree of synchronization of playing of users of a subset. According to an embodiment, the apparatus is further caused to receive image data from users of the subset while playing the music items, and provide received image data arranged to be displayed to said at least one user simultaneously with playing of the music items. According to an embodiment, at least one further user joins the subgroup for playing a further music item related to said same music item. According to an embodiment, the playing of the music item of said at least one further user is provided to the user with the playing of the music items from other users of the subset. According to an embodiment, the playing of the music item of said at least one further user is combined with the playing of the music items from users of the subset.

### DESCRIPTION OF THE DRAWINGS

In the following, various embodiments of the invention will be described in more detail with reference to the appended drawings, in which

FIG. 1a shows an example of an online music playing service system according to an embodiment;

FIG. 1b shows an example of an online music playing service server according to an embodiment;

FIG. 2 shows an example of users of an online music playing service and subsets of users according to an embodiment;

FIG. 3 shows an example of a user of an online music playing service and the user's subset of users according to an embodiment; and

FIG. 4 shows a flow chart of a method of an online music playing service system.

### DESCRIPTION OF EXAMPLE EMBODIMENTS

Internet services and applications are used for several kinds of communication and doing things together. Through the internet people may find and reach people who are like-minded, willing and capable to participate in ongoing activity virtually. In some cases, it may be difficult to find skillful people from physical vicinity for a specific purpose needing expertise, but it may also be difficult to find such people from the internet. For people looking for music playing companion, there exists, for example, online music band services by which it is possible to make music in collaboration with others. However, finding suitable people, for example, people who share the same musical style, taste, skill level etc., to play music with in current online music band services may be difficult. Current services do not support finding suitable people. However, it might be more convenient to play with suitable people and therefore there is a need for such features.

Instead of the traditional approach where playing companions are selected arbitrarily, the embodiments of the invention provide an online music playing service system for finding and managing playing members. An online music playing service system may comprise at least one client device and a server. An online music playing service may be an application, a set of software functionalities, arranged to the server. Music items and other data, for example, image data, relating to the online music playing service may be stored in the server. The term “music item” may refer in this context to any playable piece of music, for example, a song, a composition etc. The data stored in the server may be used through the online music playing service. At least one client device may access the server in order to use the online music playing service and data relating to the service. A user of at least one client device may have a user account in order to use the online music playing service. The user may need to log in to his/her user account of the service in order to play with other users of the service. The service may automatically provide a user other suitable service members to play music with based on the users' music playing styles, taste, skills and/or preferences, etc.

In the following, several embodiments of the invention will be described in the context of example embodiments of the invention. It is to be noted, however, that the invention is not limited to shown embodiments. In fact, the different embodiments may have applications in any environment where suitable virtual companion is sought for co-doing over the internet.

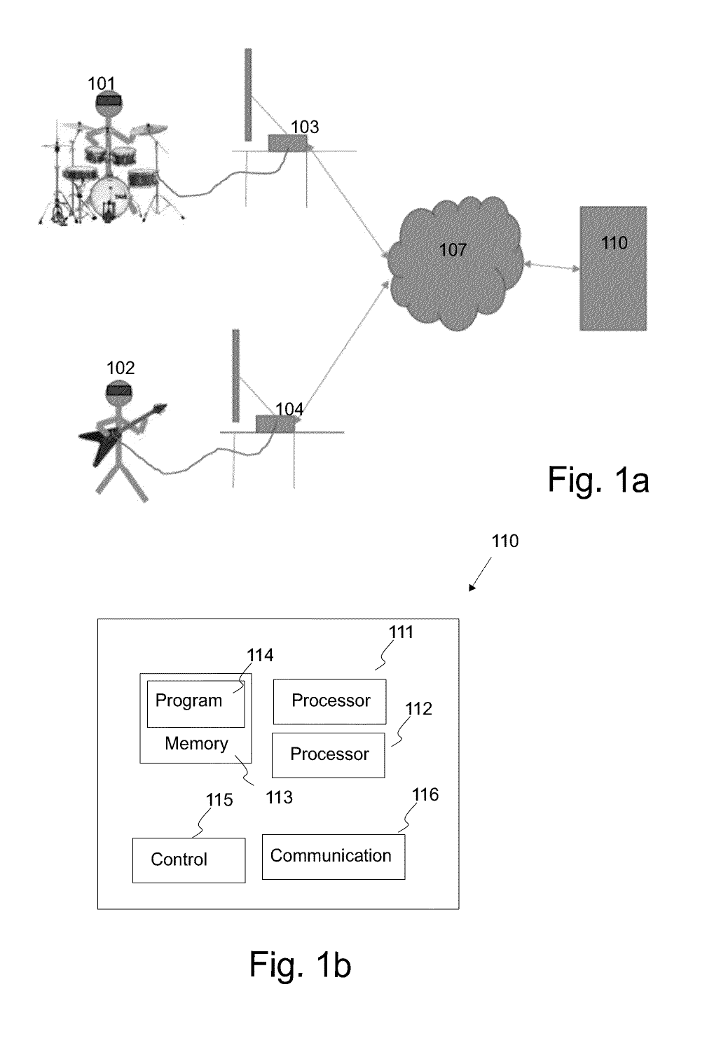

FIG. 1a shows an example of an online music playing service system 100 according to an embodiment. Users A 101 and B 102 are at their client device, for example, at their own computer 103 and 104 they are playing music instruments 105 and 106 that are connected to a service through their computers 103 and 104 and over the internet 107. User A 101 and/or B 102 may also use a listening only model, without playing an instrument. He/she may select a music item, for example, a song to listen to and be given a selection of players to hear based on his preferences. The service may be provided by a network device 110, such as a server comprising circuitry and electronics for handling, receiving and transmitting data, computer program code in a memory, and a processor that, when running the computer program code, causes the network device to carry out the features of embodiments of the invention. The server 110 may further comprise a database comprising music items, virtual world views, music videos of different bands etc.

A user A 101 and/or B 102 may initiate using the service, for example, by determining a music item or a music item list he/she is going to be playing with his/her instrument connected to a device. The device may be any suitable device comprising circuitry and electronics for handling, receiving and transmitting data, computer program code in a memory, and a processor that, when running the computer program code, causes the device to carry out the features of an embodiment of the invention. This determination of a music item or a music item list may be done, for example, by selecting a music item or a set of music items from a database provided by the service 100 or by typing the name(s) of music item(s). It is also possible that the user A 101 and/or B 102 determines a music item by just starting to play and the music item is then automatically recognized by the service. If a user wants to start playing together with someone he may search/browse music items or lists of music items that other user(s) have arranged to start playing or are already currently playing. By selecting one of those music items or list of music items, the user determines the music item or list of music items he is arranged to be playing i.e. by this determination, the user initiates using the service. The users are connected and they may commence playing together by the service. The users A 101 and B may wear virtual reality glasses while playing their musical instruments 105 and 106 for displaying virtual views, music videos, each other etc.

An apparatus according to an embodiment is illustrated in FIG. 1b in simplified manner. The apparatus may represent a server 110 of FIG. 1a. The server 110 comprises processing means, such as at least one processor 111, 112 for processing data. The server 110 further comprises memory means, such as a memory 113, storing computer program code 114, applications and various electronic data. The server 110 comprises controlling means, such as a control unit 115, for controlling functions in the server 110. The control unit 115 may run a user interface software to facilitate user control of at least some functions of the server 110. The control unit 115 may communicate with the processor 111, 112 and can access the memory 113. Further, the server 110 may comprise input means (not shown). Yet further, the server 110 comprises various data transfer means, such as a communication block 116 having a transmitter and a receiver for connecting to a network and for transmitting and receiving information, for example, playing of musical instrument. The communication means can be adapted for telecommunications and/or wide-range and/or short range communication.

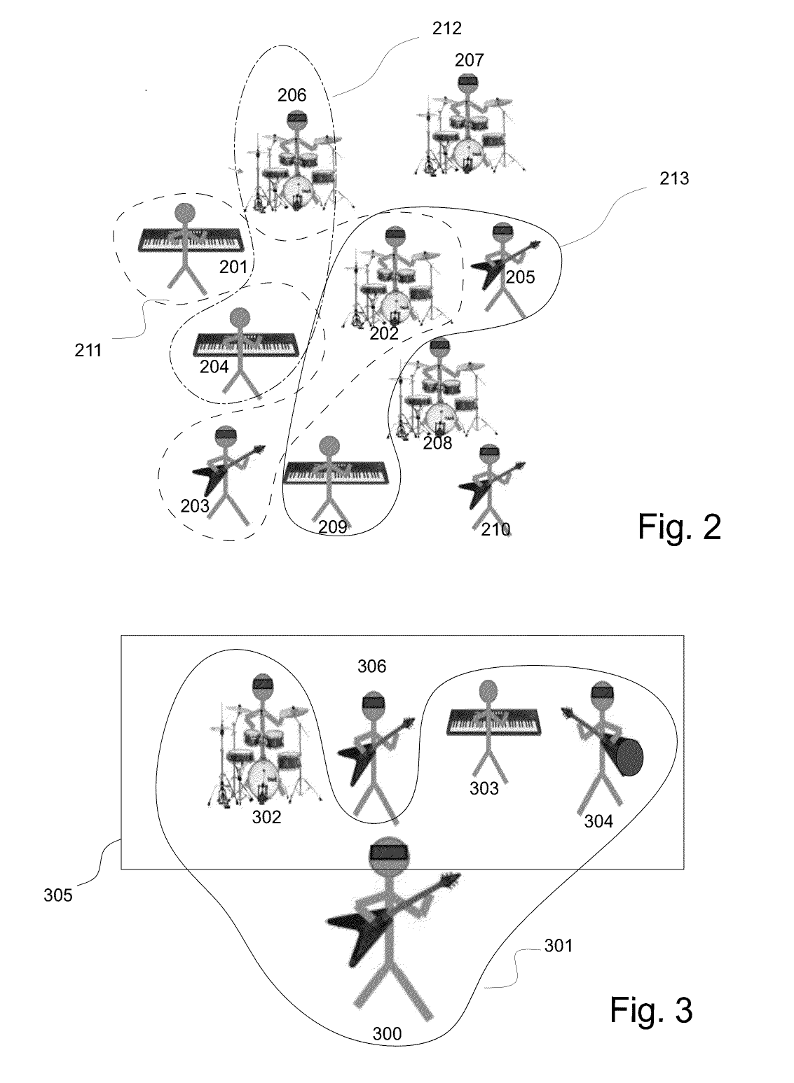

FIG. 2 shows an example of users of an online music playing service according to an embodiment. A user 201 has decided he wants to start playing ‘Smoke on the Water’. He may log on to the service, if he has not already done so. He may search from the service other users that already were playing “Smoke on the Water”. If he does not find any, he may determine to the service that he is going to play ‘Smoke on the Water’. Other users of the service who also want to play ‘Smoke on the Water’ may search for ‘Smoke on the Water’ and find the User's 201 entry. They may join him to play, by determining the ‘Smoke on the Water’ already determined by the User 201. All users are allowed to join playing with user 201. This joined group of users determined to play the same music item may be called a co-players group, and users of the co-players group may be called co-players. In this example, there are 3 guitarists, 3 keyboard players and 4 drummers. Having this many players playing together may lead to a non-pleasant, chaotic playing session. For this reason, the service may define, for each user 201-210, a set of users i.e. a subset of users to play with; the user may only hear the playing of users, i.e., only defined set of users are audible for the user. Playing of users of other subset(s) of users are non-audible, i.e., silent for the him/her. The user also hears his/her own playing, because he/she is a part of the subset selected for him/her.

One example of defined subset of users 211 is shown in FIG. 2. This subset of users 211 is defined for a user 201, i.e., the user 201 is the owner of the defined subset of users 211, but also part of the subset 211. The user 201 (a keyboardist) is connected to the user 202 (a drummer) and the user 203 (a guitarist) that have been automatically defined for him by the service.

A second example of defined subset of users 212 is also shown in FIG. 2. The defined subset of users 212 is defined for the user 204. This user 204 (a keyboardist) is connected to the user 206 (a drummer) only. The user 202 may have indicated in his preference to not to jam with guitarist users. The user may indicate his/her preference, for example, in connection with his/her user account or in his/her profile information stored in the service.

A third example of defined subset of users 213 is also shown in FIG. 2. The defined subset of users 213 is defined for the user 202, the owner of the defined subset of users 213. The user 202 (a drummer) is connected to the user 208 (a guitarist) and the user 209 (a keyboardist) that have again been automatically defined for him by the service.

It may have been arranged so that only owners of the subsets of users may hear playing of other members of their subsets of users in addition to their own playing. In other words, for example, the user 201 that is the owner of the defined subset of users 211 may hear playing of users 202 and 203 that are members of his own defined subset of users 211 in addition to his own playing; the user 202 that is the owner of the defined subset of users 212 may hear playing of users 205 and 209 that are members of his own defined subset of users 211 in addition to his own playing; and the user 203 may hear playing of users that are members of his own defined subset of users (not shown) in addition to his own playing. In other words, one user can play in/can be defined into one or more subsets of users, but he/she will hear playing of users of only one subset of users. For example, the user 202 has been defined into two subsets of users 211 and 213, but he hears only playing of the subset of users that is defined just for him/her, which is 213 in this embodiment. These subsets of users may be totally different for each user of the service (co-players) or there may also be one or more subsets of users that comprise the same users.

Playing of users may be provided to be outputted in real time to a user, for example, an owner of a defined subset of users. In this case the service allows users to play together in real-time over the internet. They may or may not play synchronously, the service does not process their playing. Alternatively, playing of users may be provided i.e. outputted simultaneously. In this case the service has processed users playing signals so that playing of a music item of all users of a subgroup (including the owner) are in sync when they are provided for outputting.

In addition playing of users of a subgroup may also be combined before or during outputting the playing of a music item as combined playing.

A service according to embodiments of the invention may define a subset of users for a user on the basis of several different selection methods. The service may select a subset of users for a user on the basis of his/her preferences from a co-players group, if/when the user has indicated in his/her user's preferences that he/she wants to play. He/she may indicate, for example, that he/she wants to play with players playing certain instruments only, for example no guitar, only distortion guitar, 2 keyboards, 1 drums etc.

Alternatively, the service may define a subset of users for a user on the basis of skill level of co-players. In this embodiment, the system may automatically match co-players of similar skill level. Skill level may be determined by performing ‘tests’ before a first playing session in the service or later on. The service may determine skill level also on the basis of at least one previous playing session in the service.

Alternatively, the service may define a subset of users for a user on the basis of co-players reputation. In this embodiment, the service may collect a reputation score for its users, e.g., on the basis of previous playing sessions.

Alternatively, the service may define a subset of users for a user on the basis of history of playing together. For example, if the users have been chosen to play together many times before in previous playing sessions, they might be put together again.

Alternatively, the service may define a subset of users for a user on the basis of their playing style match. The service may analyze the playing of users for attributes such as tempo, tempo fluctuation, musical key, etc. These may be then compared with other co-players to find matches. The analyzing of playing of users may be done at the client end. Users' computers may analyze their user's playing. This playing analysis information may be transmitted to the service, for example, along with the playing, or the analysis information may be stored in user profile information or in connection with user account. However, it is also possible that the service is arranged to perform this playing analysis.

Alternatively, it is possible that the service uses more than one of the above mentioned selection methods, when selecting subset of users for each user among co-players. In addition, it is possible, in some cases, that the user wants to define users with whom he/she is playing with. In which case, the user may manually define his/her subset of users among co-players.

The service may also implement a virtual world for users to play in. The users may be shown a view, where they are virtually playing in different venues, i.e., in a different virtual world, for example, in a stadium, a famous studio or a garage. The virtual view of a venue could be shown to the users, for example, through virtual reality glasses or on a display of a device connecting the user to the service or by some other way. The service may define a virtual view arranged to be displayed for a user, for example, on the basis of the degree of synchronization of playing of users of a subset, i.e., how much in sync the playing of users of the subset are to each other. When the degree of synchronization of a subset of users is high or over a predetermined level of synchronization, they are offered a ‘cooler’ or better virtual world to play in. When the degree of synchronization of a subset of users is low or below a predetermined degree they are offered a ‘not-cool’ or boring virtual world to play in.

In addition, the virtual view, i.e., virtual world arranged to be displayed for one or more users of a subset may improve as a function of the degree of synchronization from a poor place to a glamourous place. For example, the service may first show a virtual garage view, and after the degree of synchronization improves, the garage may change to a club and then to a concert hall and finally to a stadium. In addition or instead of the degree of synchronization, the degree of match of playing style of subset users may affect the shown virtual view. In addition to the degree of synchronization and/or match of playing style, a number of listeners of a subset of users may affect the shown virtual view; the more listening users a user/a subset has, the better place the user is offered to play in by the service. In addition, combination of these may affect the displayed virtual view. Users may join only in listening mode to the service and determine a music item or a music item list. Also for them, a subset of users may be defined from the co-player group arranged to play the determined music item or music item list.

There may also be other visualizations than venue i.e. world. For example, a user may see other people playing in the virtual world around him/her. The service may receive image data, for example, video about users and show this received video about users of a subset for the user (owner of the subset).

Further the ones with whom the user has a higher degree of synchronization and/or match of playing style may be the ones the user hears or hears loudest and they may also appear closest in the shown virtual view. The user (owner of the subset) may select other users of his/her subset, who are farther away, and modify his/her style in order to achieve a better playing style match and/or degree of synchronization with them. When the user achieves this, the original best matches move farther while the new matches move closer to the user. Spatial audio may also be used to play the audio of the different players.

It is also possible, that a user is arranged to be playing with a selected real-life band, for example, in a music video view of the band. In this case, it is possible that the user is shown on stage with them. For example, the user playing guitar may audibly replace the original guitarist of the band and he/she may also be shown instead of him/her in the virtual view. In this case, the user is an owner of a subset of users, wherein users of the subset are other players of the real-life band. An example, of this kind of subset is shown in FIG. 3, wherein user 300 is a guitarist and his subset of users 301 comprises members 302, 303 and 304 of the band 305 excluding the guitarist 306 of the band 305. The user 300 plays guitar and guitar of guitarist 306 is not audible to him. Any other player of the band 305 may also be replaced by a user playing that instrument arranged to be replaced. For example, a drummer user may replace the drummer player 302 of the band 305. In addition, it is possible, that the two or more players of the band 605 are replaced by users of the service. In other words, a subset of players may also comprise one or more players of a real-life band and two or more users connected to the online music playing service.

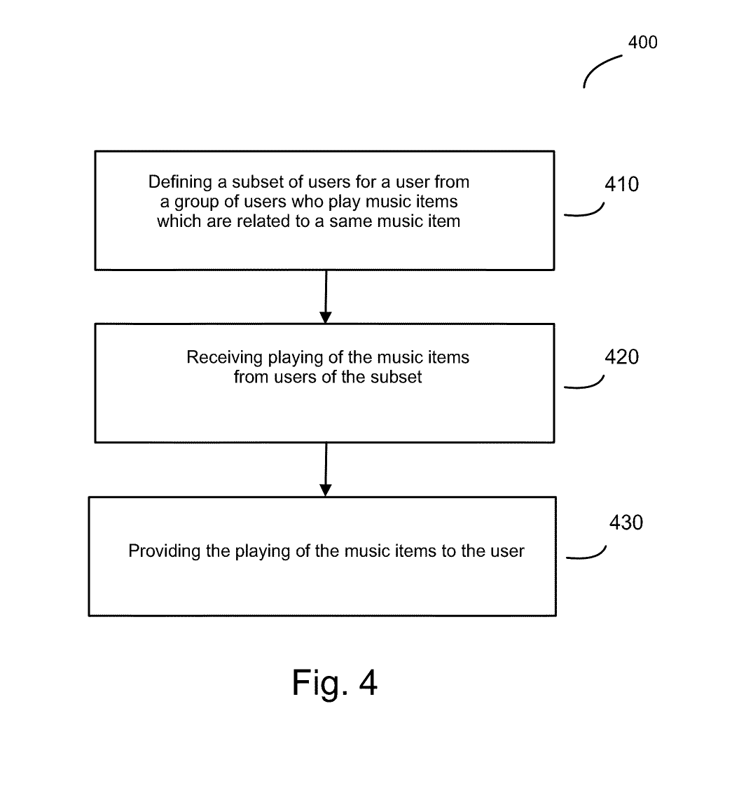

FIG. 4 shows a flow chart of a method of an online music playing service system 400. In the method 400, in step 410 a subset of users for a user from a group of users who play music items which are related to a same music item are defined. They may play, for example, same song. In step 420, playing of the music items from users of the subset is received. The service may receive playing of music items from users devices. In step 630, the playing of the music items is provided to the user. The service may provide playing of the music items to user's device to be outputted.

A client device connected to the online music playing service over the internet and connecting musical instrument to the service may be any suitable device. User's musical instrument may be connect to the client device for transmitting music signal data i.e. playing to the service and receiving and outputting audio signal comprising music signals played by users i.e. playing of users of a subset defined for the user of the client device. The client device may comprise audio output means, for example, an earpiece audio, a headset or headphone or the like. The client device may also receive video signal and/or visual world views from the service to be viewed for the user of the client device by displaying means. Displaying means may be virtual reality glasses connected to the client device or a display of a client device or a display connected to a client device. The client device may also comprise an interface means (e.g. a user interface) which allows a user to interact with the device and the service over the internet. The user interface means may be implemented by using one or more of the following: the display, a keypad, or other structures. The device may be connected to the server and service e.g. by means of a communication block able to receive and/or transmit information through a wireless or wired network over the internet or any other type of connection. The client device may further comprise a microphone or any suitable audio input which may be a digital or analogue signal input. In other embodiments, the device may further comprise any suitable short range communication solution such as, for example, a Bluetooth wireless connection, Near Field Communication (NFC) connection or a USB/firewire wired connection in order to connect an instrument to the client device. The musical instrument may be connected to the client device also by wired connection. The device may further comprise a camera sensor for transmitting image data, for example, from the user to the service. The client device may be, for example, a personal computer, a laptop, a game console or a mobile terminal, for example, a mobile phone, a smart phone, a camera device, a tablet device or other type of a smart device. Embodiments of the invention may also be implemented within any other electronic device or apparatus comprising suitable means.

Instruments suitably connected to a client device and to be used in connection with the service and server are not restricted to shown instruments. Other possible instruments are, for example, a bass, ukulele, violin and banjo etc. Any instrument that may be arranged to be used in context with the service may be suitable. Instruments may be electrical instruments and they are electrically connected to a client device of a user in order to transmit playing signals to a service. However, it is also possible that acoustic instruments are used. Acoustic instruments playing may be transmitted to the service through a microphone of a client device or a microphone connected to the client device.

The service may also change at least one user of a subset of users, if it finds better or more suitable co-players to that subset. This may be possible, for example, if one or more users join to play a music item at a later stage of playing the music item.

In addition, one or more users may also join the subgroup for playing said same music item. Playing of the music item of joined user may be provided to the user to be outputted with the playing of the music items from other users of the subset. The playing of the music item of the joined user may be combined with the playing of the music items from users of the subset.

The number of users of a subset of users is not restricted, it may be two, three or up to ten. The number may depend, for example, on instruments of existing co-players determined to play a music item. However, in some cases, the number of users may even be higher, for example, 20 or 30. This may be the case, for example, with classical instruments forming an orchestra.

A subset of users may be redefined if one or more user leave the service during playing. For example, if a drummer leaves, the service may a select a new drummer to replace the one who left.

The various embodiments of the invention can be implemented with the help of computer program code that resides in a memory and causes the relevant apparatuses to carry out the invention.

It is obvious that the present invention is not limited solely to the above-presented embodiments, but it can be modified within the scope of the appended claims.

1. A method, comprising:
defining a subset of users for a user from a group of users who play music items which are related to a same music item;
receiving playing of the music items from users of the subset; and
providing the playing of the music items to the user.

2. The method according to claim 1, wherein the subset of users is automatically defined for the user on the basis of user's preferences, skill level of users of the group, collected reputation score of users of the group, playing style match between the user and users of the group or history of playing together.

3. The method according to claim 1, wherein the subset of users is defined by the user.

4. The method according to claim 1, wherein a subset of users is defined for each user of the group.

5. The method according to claim 1, wherein playing of the music items is provided in real time to the user.

6. The method according to claim 1, wherein playing of the music items is provided simultaneously to the user.

7. The method according to claim 1, wherein at least one received music item is played with a different music instrument than at least one other received music item.

8. The method according to claim 1, wherein the playing of the music items is combined and the combined playing is provided to the user.

9. The method according to claim 1, wherein the method further comprises
defining a virtual view arranged to be displayed with playing of the music items.

10. The method according to claim 9, wherein the virtual view is defined on the basis of the degree of synchronization of playing of users of a subset.

11. The method according to claim 1, wherein the method further comprises
receiving image data from users of the subset while playing the music items; and
providing received image data arranged to be displayed to said at least one user simultaneously with playing of the music items.

12. The method according to claim 1, wherein at least one further user joins the subgroup for playing a further music item related to said same music item.

13. The method according to claim 12, wherein the playing of the music item of said at least one further user is provided to the user with the playing of the music items from other users of the subset.

14. The method according to claim 12, wherein the playing of the music item of said at least one further user is combined with the playing of the music items from users of the subset.

15. An apparatus comprising at least one processor, and memory including computer program code, the memory and the computer program code configured to, with the at least one processor, cause the apparatus to perform at least the following:
define a subset of users for a user from a group of users who play music items which are related to a same music item;
receive playing of the music items from users of the subset; and
provide the playing of the music items to the user.

16. The apparatus according to claim 15, wherein the subset of users is automatically defined for the user on the basis of user's preferences, skill level of users of the group, collected reputation score of users of the group, playing style match between the user and users of the group or history of playing together.

17. The apparatus according to claim 15, wherein at least one received music item is played with a different music instrument than at least one other received music item.

18. The apparatus according to claim 15, wherein the playing of the music items is combined and the combined playing is provided to the user.

19. The apparatus according to claim 15, wherein the apparatus is further caused to
define a virtual view arranged to be displayed with playing of the music items,
wherein virtual view is defined on the basis of the degree of synchronization of playing of users of a subset.

20. A computer program embodied on a non-transitory computer readable medium, the computer program comprising instructions causing, when executed on at least one processor, at least one apparatus to
define a subset of users for a user from a group of users who play music items which are related to a same music item;
receive playing of the music items from users of the subset; and
provide the playing of the music items to the user.
